(19) United States
(12) Patent Application Publication
(10) Pub. No.: US 2015/0069071 A1
(43) Pub. Date: Mar. 12, 2015

(54) Layered Inspectable Pressure Vessel for CNG Storage and Transportation

(71) Applicants: Francesco Nettis, London (GB); Paolo Redondi, Milano (IT); Vanni Neri Tomaselli, Luxembourg (LU)

(72) Inventors: Francesco Nettis, London (GB); Paolo Redondi, Milano (IT); Vanni Neri Tomaselli, Luxembourg (LU)

(73) Assignee: BLUE WAVE CO S.A., Luxembourg (LU)

(21) Appl. No.: 14/363,177

(22) PCT Filed: Dec. 5, 2011
(86) PCT No.: PCT/EP2011/071797

§ 371 Date: Nov. 20, 2014

(51) Int. Cl. F17C 1/06

(52) U.S. Cl. CPC F17C 1/06; F17C 2201/0109; F17C 2203/0639; F17C 2203/0656; F17C 2221/033
USPC 220/582; 220/590

(57) ABSTRACT

An inspectable pressure vessel (10) for containing a fluid such as CNG, the vessel having a generally cylindrical shape over a majority of its length, at least one opening for gas loading and offloading and for liquid evacuation, at least one stainless steel layer as a first layer (100) for being in contact with the fluid when the fluid is contained within the vessel, the first layer being made of low-carbon stainless steel, and a further external composite layer (200) made of at least one fiber-reinforced polymer layer that will not be in contact with the fluid when the fluid is contained within the vessel.

### FIELD OF THE INVENTION

The present invention relates to a pressure vessel for CNG (Compressed Natural Gas) more in particular for sea transportation.

### DESCRIPTION OF PRIOR ART

Increased capacity and efficiency requests in the field of CNG transportation, and the common use of steel-based cylinders therefor, has led to the development of steel-based cylinders with a thicker structure, which usually results in a heavy device or a device with a lower mass ratio of transported gas to containment system. This effect can be overcome with the use of advanced and lighter materials such as composite structures. After all, seafaring vessels have a load-bearing limit based upon the buoyancy of the vehicle, much of which load capacity is taken up by the physical weight of the vessels—i.e. their “empty” weight.

Some existing solutions therefore already use composite structures in order to reduce the weight of the device, but the size and configuration of the composite structures are not optimized, for example due to the limitations of the materials used. For example, the use of small cylinders or non-traditional shapes of vessel often leads to a lower efficiency in terms of transported gas (smaller vessels can lead to higher non-occupied space ratios) and a more difficult inspection of the inside of the vessels. Further, the use of partial wrapping (e.g. hoop-wrapped cylinders) for covering only the cylindrical part of the vessel, but not the ends of it, leads to an interface existing between the wrapped portion of the vessel and the end of the vessel where only the metal shell is exposed. That too can lead to problems, such as corrosion.

Also, transitions between materials in a continuous structural part usually constitute a weaker area, and hence the point in which failures are more likely to occur.

The present invention seeks to provide an alternative design of pressure vessel.

### SUMMARY OF THE INVENTION

According to the invention, there is provided an inspectable pressure vessel for containing a fluid, the vessel having a generally cylindrical shape over a majority of its length and at least one stainless steel layer as a first layer for being in contact with the fluid when the fluid is contained within the vessel, the first layer being made of low-carbon stainless steel, and a further external composite layer made of at least one fiber-reinforced polymer layer that will not be in contact with the fluid when the fluid is contained within the vessel.

The vessel may have an opening for gas loading and offloading and for liquid evacuation. Preferably that opening is at the bottom of the vessel. Preferably the vessel is for standing vertically, such that the cylindrical section thereof is substantially vertical.

Preferably one end of the vessel has a closeable opening in the form of a manhole for allowing internal inspection, and closing means for allowing sealed closing of the opening,. Preferably the manhole is at the top of the vessel. The manhole may be a 24 inch (60 cm) manhole, or equivalent, for allowing internal inspection, e.g. by a person climbing into the vessel.

A plurality of the inspectable pressure vessels (10) can be arranged in a module or compartment, and the pressure vessels can be interconnected for loading and offloading operations.

Preferably the vessels all have the same height. Some may have different heights, however, to accommodate a variable floor condition—such as the curvature of a hull of a ship.

Preferably the vessel or module or container is fitted on a ship, or some other form of transporter, such as a vehicle or train.

Other preferred and non-essential features of the present invention are set out in the dependent claims, as appended hereto.

### BRIEF DESCRIPTION OF THE DRAWINGS

These and other features of the present invention will now be described, purely by way of example, with reference to the accompanying drawings, in which:

FIG. 1 is a schematic view showing a pressure vessel according to the invention;

FIG. 2 is a partially sectioned view showing schematically a layered composition of a pressure vessel according to the present invention;

FIG. 3 is a schematic perspective view showing interconnecting piping between vessels according to the invention, arranged in a module;

FIG. 4 is a schematic side view showing the interconnecting piping between vessels lined up within a module;

FIG. 5 is a schematic top view showing the interconnecting piping between vessels lined up within a module;

FIG. 7 schematically shows a section through a ship hull showing two modules arranged side by side; and

FIG. 8 schematically shows a more detailed view of the top-side pipework.

### DESCRIPTION OF THE PREFERRED EMBODIMENTS

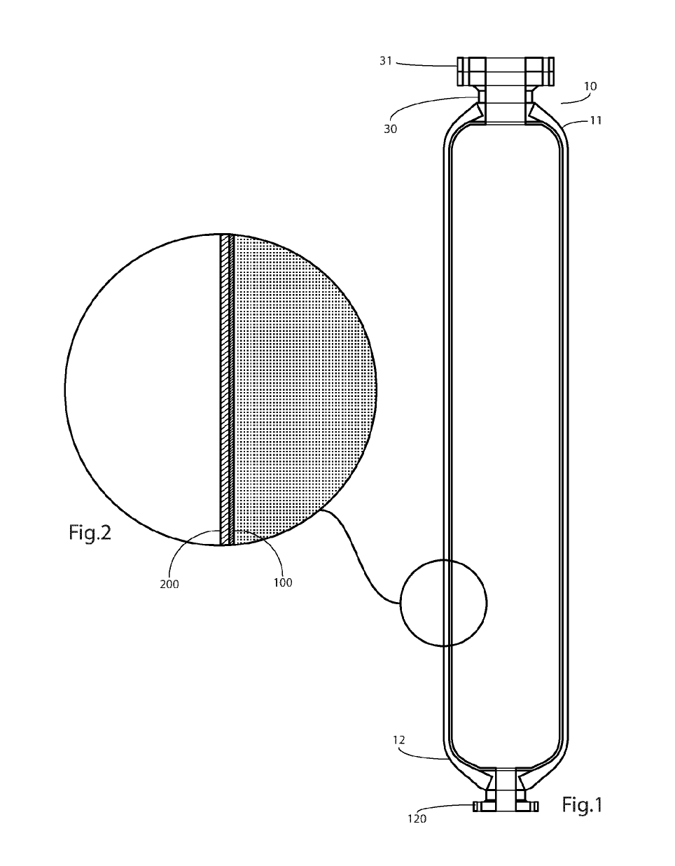

The pressure vessel (10), mentioned in these embodiments and shown as an example in FIG. 1 and FIG. 2, is made of an internal metallic liner as at least a first layer (100) capable of hydraulic or fluidic containment of raw gases such as CNG (20) (Compressed Natural Gas), with an external composite layer (200).

Said metallic liner, as the first layer (100), is not needed to be provided in a form to provide a structural aim during CNG (20) transportation, in particular such as during sea or marine transportation, or during loading and offloading phases. However, it is preferred that it should be at least corrosion-proof. Further it is preferred for it to be capable of carrying non-treated or unprocessed gases. Hence the preferred material is a stainless steel, or some other metallic alloy.

This construction also allows the tank to be able to carry other gases, such as natural gas (methane) with CO2 allowances of up to 14% molar, H2S allowances of up to 1.5% molar, or H₂ and CO₂ gases. The preferred use, however, is CNG transportation.

CNG can include various potential component parts in a variable mixture of ratios, some in their gas phase and others in a liquid phase, or a mix of both. Those component parts will typically comprise one or more of the following compounds: C2H6, C3H8, C4H10, C5H12, C6H14, C7H16, C8H18, C9+ hydrocarbons, CO2 and H2S, plus potentially toluene, diesel and octane in a liquid state.

The stainless steel is preferably an austenitic stainless steel such as AISI 304, 314, 316 or 316L (with low carbon percentages). Where some other metallic alloy is used, it is preferably a Nickel-based alloy or an Aluminum-based alloy, such as one that has corrosion resistance.

The metallic liner forming the first layer (100) preferably only needs to be strong enough to withstand stresses arising from manufacturing processes of the vessel, so as not to collapse on itself, such as those imposed thereon during fiber winding. This is because the structural support during pressurized transportation of CNG (20) will be provided instead by the external composite layer (200).

The external composite layer (200), which uses at least one fiber layer, will be a fiber-reinforced polymer. The composite layer can be based on glass, or on carbon/graphite, or on aramid fibers, or on combinations thereof, for example. The external composite layer is used as a reinforcement, fully wrapping the pressure vessels (10), including vessel ends (11, 12), and providing the structural strength for the vessel during service. In case of glass fibers, is it preferred but not limited to the use of an E-glass or S-glass fiber. Preferably, however, the glass fiber has a suggested tensile strength of 1,500 MPa or higher and/or a suggested Young Modulus of 70 GPa or higher. In case of carbon fibers, is it preferred but not limited to the use of a carbon yarn, preferably with a tensile strength of 3,200 MPa or higher and/or a Young Modulus of 230 GPa or higher. Preferably there are 12,000, 24,000 or 48,000 filaments per yarn.

The composite matrix is preferred to be a polymeric resin thermoset or thermoplastic. If a thermoset, it may be an epoxy-based resin.

The manufacturing of the external composite layer (200) over the said metallic liner (the first layer (100)) preferably involves a winding technology. This can potentially gives a high efficiency in terms of production hours. Moreover it can potentially provide good precision in the fibers' orientation. Further it can provide good quality reproducibility.

The reinforcing fibers preferably are wound with a back-tension over a mandrel. The mandrel is typically the liner. The liner thus constitutes the male mould for this technology. The winding is typically after the fibers have been pre-impregnated in the resin. Impregnated fibers are thus preferably deposed in layers over said metallic liner until the desired thickness is reached for the given diameter. For example, for a diameter of 6 m, the desired thickness might be about 350 mm for carbon-based composites or about 650 mm for glass-based composites.

Since this invention preferably relates to a substantially fully-wrapped pressure vessel (10), a multi-axis crosshead for fibers is preferably used in the manufacturing process.

The process preferably includes a covering of the majority of the ends (11, 12) of the pressure vessel (10) with the structural external composite layer (200).

In the case of the use of thermoset resins there can be a use of an impregnating basket before the fiber deposition—for impregnating the fibers before actually winding the fibers around the metal liner (100).

In the case of the use of thermoplastic resins, there can be a heating of the resin before the fiber deposition in order to melt the resin just before reaching the mandrel, or the fibers are impregnated with thermoplastic resin before they are deposited as a composite material on the metal liner. The resin is again heated before depositing the fibers in order to melt the resin just before the fiber and resin composite reaches the metal liner (100).

The pressure vessel (10) is provided with an opening (120) (here provided with a cap or connector) for gas loading and offloading, and for liquid evacuation. It is provided at the bottom end 12 and it can be a 12 inch (30 cm) opening for connecting to pipework.

The vessel also has an opening 31 at the top end (11) and it is in the form of a manhole (30). Preferably it is at least an 18 inch (45 cm) wide access manhole, such as one with a sealable cover (or more preferably a 24 inch (60 cm) manhole). Preferably it fulfills ASME standards. It is provided with closing means (31), allowing sealed closing of the opening, such as by bolting it down. The manhole allows internal inspection of the vessel, such as by a person climbing into the vessel.

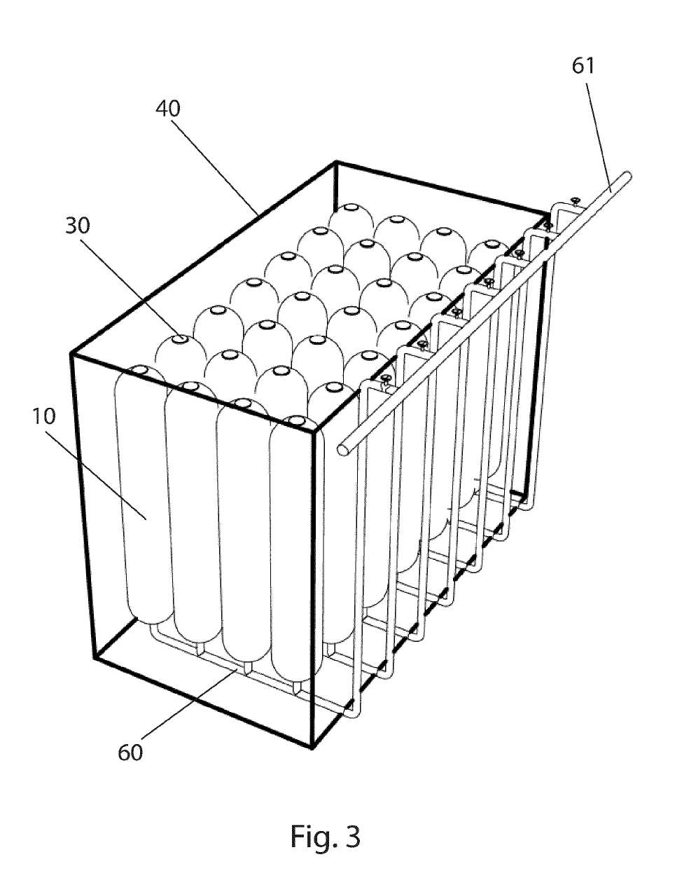

Referring now to FIG. 3, a plurality of the pressure vessels (10) are arranged in a ship's hull (see FIG. 6) in modules or in compartments 40 and they can be interconnected, for example for loading and offloading operations, such as via pipework 61.

In the preferred configuration, the modules or compartments 40 have four edges (i.e. they are quadrilateral-shaped) and contain a plurality of vessels 10. The number of vessels chosen will depend upon the vessel diameter or shape and the size of the modules or compartments 40. Further, the number of modules or compartments will depend upon the structural constraints of the ship hull for accommodating the modules or compartments 40. It is not essential for all the modules or compartments to be of the same size or shape, and likewise they need not contain the same size or shape of pressure vessel, or the same numbers thereof.

The vessels 10 may be in a regular array within the modules or compartments in the illustrated embodiment a 4×7 array. Other array sizes are also to be anticipated, whether in the same module (i.e. with differently sized pressure vessels), or in differently sized modules, and the arrangements can be chosen or designed to fit appropriately in the ship's hull.

Preferably the distance between pressure vessel rows within the modules or compartments will be at least 380 mm, or more preferably at least 600 mm, for external inspection-ability reasons, and to allow space for vessel expansion when loaded with the pressurised gas the vessels may expand by 2% or more in volume when loaded (and changes in the ambient temperature can also cause the vessel to change their volume).

Preferably the distance between the modules or compartments (or between the outer vessels (10A) and the walls or boundaries (40A) of the modules or compartments (40), or between adjacent outer vessels of neighbouring modules or compartments (40), such as where no physical wall separates neighbouring modules or compartments (40) will be at least 600 mm, or more preferably at least 1 meter, again for external inspection-ability reasons, and/or to allow for vessel expansion.

Each pressure vessel row (or column) is interconnected with a piping system 60 intended for loading and offloading operations. The piping 60 is shown to be connected at the bottom of the vessels 10. It can be provided elsewhere, but the bottom is preferred.

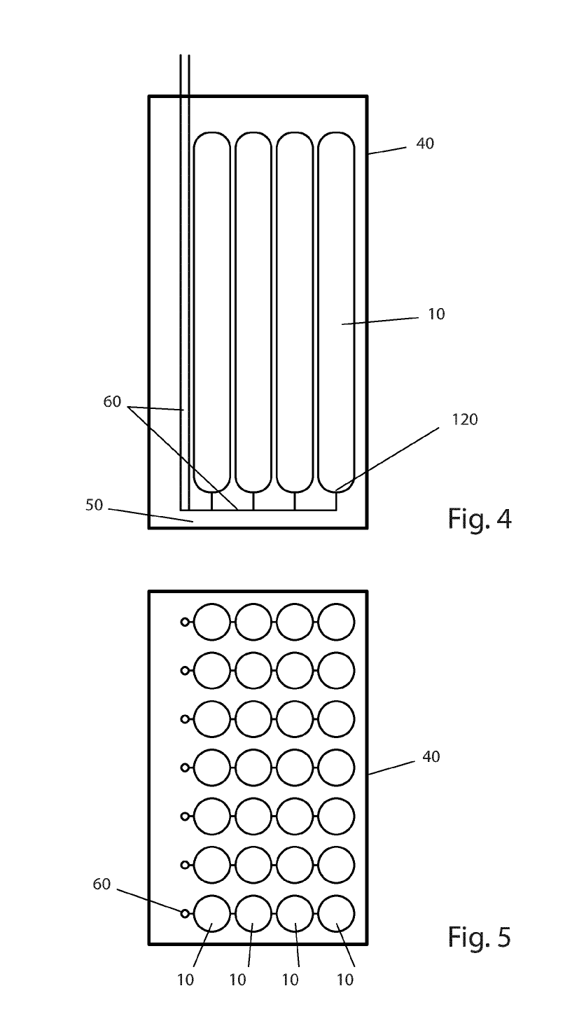

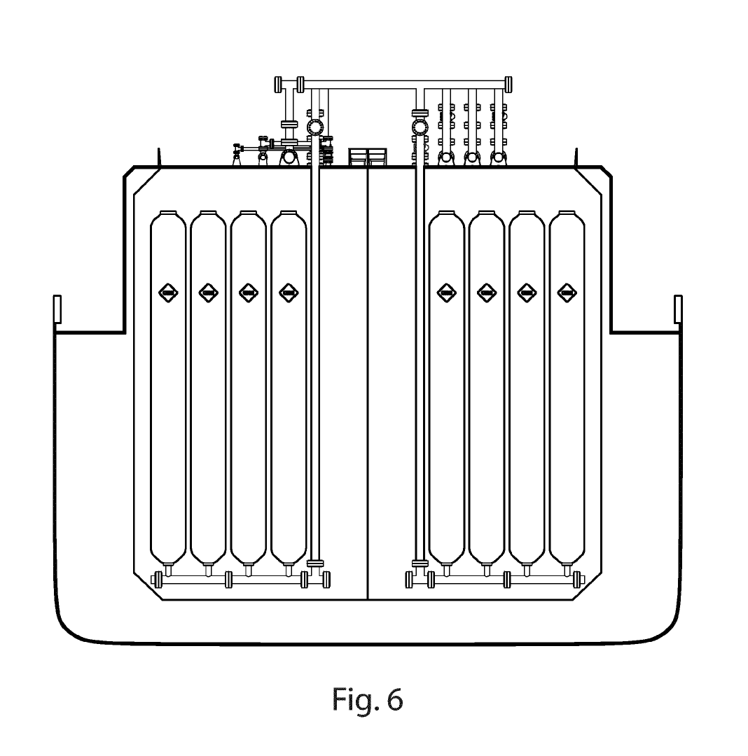

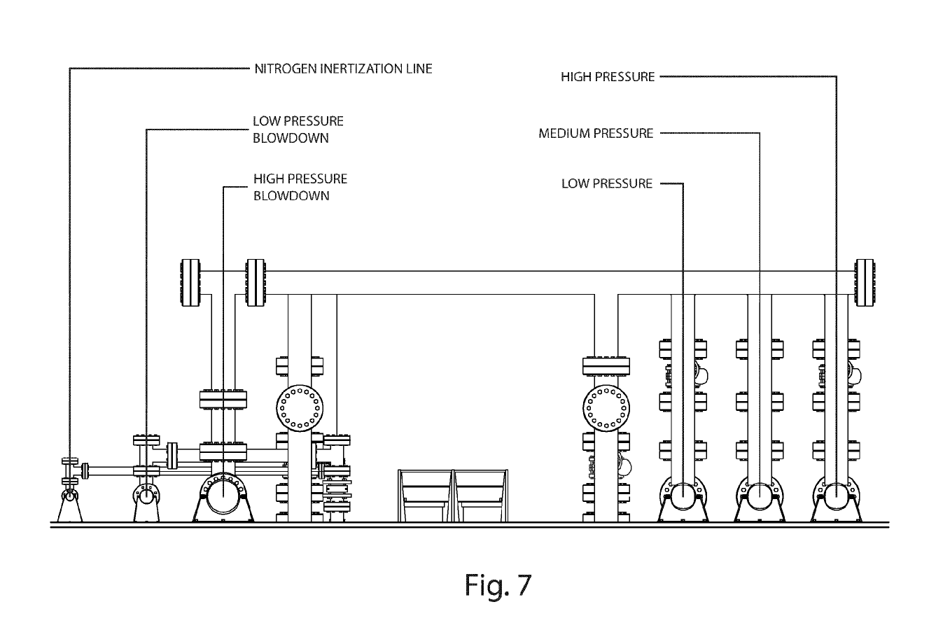

In a preferred arrangement, the piping connects via the 12 inch (30 cm) opening 120 at the bottom of the vessel 10. The connection is to main headers, and preferably through motorized valves. The piping is schematically shown, by way of an example, in FIGS. 3 to 7.

The main headers can consist of various different pressure levels, for example three of them (high—e.g. 250 bar, medium—e.g. 150 bar, and low—e.g. 90 bar), plus one blow down header and one nitrogen header for inert purposes.

The vessels 10 are preferred to be mounted vertically, such as on dedicated supports or brackets, or by being strapped into place. The supports (not shown) hold the vessels 10 in order to avoid horizontal displacement of the vessels relative to one another. Clamps, brackets or other conventional pressure vessel retention systems, may be used for this purpose, such as hoops or straps that secure the main cylinder of each vessel.

The supports can be designed to accommodate vessel expansion, such as by having some resilience.

Vertically-mounted vessels have been found to give less criticality in following dynamic loads due to the ship motion and can allow an easier potential replacement of single vessels in the module or compartment they can be lifted out without the need to first remove other vessels from above. This arrangement also allows a potentially faster installation time. Mounting vessels in vertical position also allows condensed liquids to fall under the influence of gravity to the bottom, thereby being off-loadable from the vessels, e.g. using the 12 inch opening (120) at the bottom (12) of each vessel (10).

Offloading of the gas typically will be also from the bottom of the vessel 10.

With the majority of the piping and valving 60 positioned towards the bottom of the modules/bottom of the vessels, this positions the center of gravity also in a low position, which is recommended or preferred, especially for improving stability at sea, or during gas transportation.

Modules or compartments 40 can be kept in controlled environment with nitrogen gas being between the vessels (10) and the modules' walls (40A), thus helping to prevent fire occurrence or fire hazard. Alternatively, the engine exhaust gas could be used for this inerting function thanks to its composition being rich in CO₂.

Maximization of the size of the individual vessels 10, such as by making them up to 6 m in diameter and/or up to 30 m in length, reduces the total number of vessels needed for the same total volume contained. Further it serves to reduce connection and inter-piping complexity. This in turn reduces the number of possible leakage points, which usually occur in weaker locations such as weldings, joints and manifolds. Preferred arrangements call for diameters of at least 2 m.

One dedicated module can be set aside for liquid storage (condensate) using the same concept of interconnection used for the gas storage. The modules are thus potentially all connected together to allow a distribution of such liquid from other modules (40) to the dedicated module a ship will typically feature multiple modules.

In and out gas storage piping is linked with metering, heating and blow down systems and scavenging systems, e.g. through valved manifolds. They can be remotely activated by a Distributed Control System (DCS).

Piping diameters are preferably as follows:

18 inch. for the three main headers (low, medium and high pressure) dedicated to CNG loading/offloading.

24 inch. for the blow-down CNG line.

6 inch. for the pipe feeding the module with the inert gas.

10 inch. for the blow-down inert gas line.

10 inch. for the pipe dedicated to possible liquid loading/offloading.

All modules are typically equipped with adequate firefighting systems, as foreseen by international codes, standards and rules.

The transported CNG will typically be at a pressure in excess of 60 bar, and potentially in excess of 100 bar, 150 bar, 200 bar or 250 bar, and potentially peaking at 300 bar or 350 bar.

The pressure vessels described herein can carry a variety of gases, such as raw gas straight from a bore well, including raw natural gas, e.g. when compressed—raw CNG or RCNG, or H2, or CO2 or processed natural gas (methane), or raw or part processed natural gas, e.g. with CO2 allowances of up to 14% molar, H2S allowances of up to 1,000 ppm, or H2 and CO2 gas impurities, or other impurities or corrosive species. The preferred use, however, is CNG transportation, be that raw CNG, part processed CNG or clean CNG processed to a standard deliverable to the end user, e.g. commercial, industrial or residential.

CNG can include various potential component parts in a variable mixture of ratios, some in their gas phase and others in a liquid phase, or a mix of both. Those component parts will typically comprise one or more of the following compounds: C2H6, C3H8, C4H10, C5H12, C6H14, C7H16, C8H18, C9+hydrocarbons, CO2 and H2S, plus potentially toluene, diesel and octane in a liquid state, and other impurities/species.

The present invention has been described above purely by way of example. Modifications in detail may be made to the invention within the scope of the claims appended hereto.

1. An inspectable pressure vessel for containing a fluid, the vessel having a generally cylindrical shape over a majority of its length, at least one opening for gas loading and offloading and for liquid evacuation, at least one stainless steel layer as a first layer for being in contact with the fluid when the fluid is contained within the vessel, the first layer being made of low-carbon stainless steel, and a further external composite layer made of at least one fiber-reinforced polymer layer that will not be in contact with the fluid when the fluid is contained within the vessel.

2. An inspectable pressure vessel according to claim 1, wherein one end of the vessel has a closeable opening in the form of a manhole for allowing internal inspection, and closing means for allowing sealed closing of the opening.

3. An inspectable pressure vessel according to claim 1, wherein said external composite layer extends over the cylindrical shape and substantially the whole of the end portions of the pressure vessel so as to substantially entirely cover the pressure vessel.

4. An inspectable pressure vessel according to claim 1, wherein the external composite layer is in contact with an external environment surrounding the vessel.

5. An inspectable pressure vessel according to claim 1, the vessel being for CNG storage and transportation.

6. An inspectable pressure vessel according to claim 5, the vessel containing CNG.

7. An inspectable pressure vessel according to claim 1, wherein said external composite layer is based on glass fibers and epoxy resin.

8. An inspectable pressure vessel according to claim 1, wherein said external composite layer is based on carbon fibers and epoxy resin.

9. An inspectable pressure vessel according to claim 1, wherein said external composite layer is based on graphite fibers and epoxy resin.

10. An inspectable pressure vessel according to claim 7, wherein said external composite layer has glass fiber with an ultimate strength of at least 1,500 MPa and a Young Modulus of at least 70 GPa.

11. An inspectable pressure vessel according to claim 8, wherein said external composite layer has carbon fibers in carbon yarn with at strength of at least 3,200 MPa and a Young Modulus of at least 230 GPa with at least 12,000 to 48,000 filaments per yarn.

12. A module or compartment comprising a plurality of inspectable pressure vessels according to claim 1, wherein said pressure vessels are arranged in the module or the compartment and the pressure vessels are interconnected for loading and offloading operations.

13. A transporter comprising a module or compartment according to claim 12.

14. A transporter comprising a plurality of modules or compartments according to claim 12.

15. A transporter according to claim 13 wherein the transporter is a ship.
